(19) United States
(12) Patent Application Publication
(10) Pub. No.: US 2017/0187912 A1
(43) Pub. Date: Jun. 29, 2017

(54) IMAGE FORMING APPARATUS, INFORMATION PROCESSING METHOD, AND COMPUTER PROGRAM PRODUCT

(71) Applicant: Shingo TAMURA, Kanagawa (JP)

(72) Inventor: Shingo TAMURA, Kanagawa (JP)

(73) Assignee: RICOH COMPANY, LTD., Tokyo (JP)

(21) Appl. No.: 15/378,374

(22) Filed: Dec. 14, 2016

(30) Foreign Application Priority Data
Dec. 28, 2015 (JP) 2015-257445

(51) Int. Cl. H04N 1/32; H04N 1/44; H04N 1/00

(52) U.S. Cl. CPC H04N 1/32122; H04N 1/00339; H04N 1/4426; H04N 1/00408; H04N 2201/0094; H04N 2201/3205; H04N 2201/3207

(57) ABSTRACT

An image forming apparatus is capable of receiving, from a first external device that stores first information, the first information being information for an operation in the image forming apparatus. The image forming apparatus includes: an external-device access controller configured to detect an access from the first external device and receive the first information; and a screen display configured to display an operating screen for accepting an action performed on the image forming apparatus based on the received first information.

### CROSS-REFERENCE TO RELATED APPLICATION(S)

The present application claims priority under 35 U.S.C. §119 to Japanese Patent Application No. 2015-257445, filed Dec. 28, 2015. The contents of which are incorporated herein by reference in their entirety.

### BACKGROUND OF THE INVENTION

1. Field of the Invention

The present invention relates generally to an image forming apparatus, an information processing method, and a computer program product.

2. Description of the Related Art

In recent years, an image forming apparatus having a plurality of functions as, for example, a copier, a scanner, a facsimile, and a printer are widespread. Such an image forming apparatus having a plurality of functions may be referred to as an MFP (Multifunction Peripheral).

For example, when a user uses an MFP unfamiliar to the user at a location outside the user's office, the user may gain permission to use the MFP by undergoing user authentication using an external device, such as an IC (Integrated Circuit) card, and operate the MFP.

A user can store the user's various settings to an MFP that the user regularly uses (which may be referred to as “regularly-used MFP”) in advance, so that the user can use the MFP with one touch. Settings of the MFP regarding, for example, the scanner function may include a destination(s) of scan data (e.g., location where the scan data is to be stored and transmission destination), a type of original document (e.g., text or photo), a scanning size (e.g., A3 or A4), a scanning resolution (e.g., 200 dpi (dots per inch) or 300 dpi).

However, in a situation where a user uses an MFP at a location outside the user's office as in the above-described example, there are disadvantageous in that even though the user can use the MFP through user authentication, the user is required to specify (enter) various settings one by one, which is a bothering work.

### SUMMARY OF THE INVENTION

According to an aspect of the present invention, there is provided an image forming apparatus capable of receiving, from a first external device that stores first information, the first information being information for an operation in the image forming apparatus, the image forming apparatus including: an external-device access controller configured to detect an access from the first external device and receive the first information; and a screen display configured to display an operating screen for accepting an action performed on the image forming apparatus based on the received first information.

According to another aspect of the present invention, there is provided an information processing method performed by an image forming apparatus capable of receiving, from a first external device that stores first information, the first information being information for an operation in the image forming apparatus, the information processing method including: detecting an access attempt from the first external device and receiving the first information; and displaying an operating screen for accepting an action performed on the image forming apparatus based on the received first information.

According to still another aspect of the present invention, there is provided a computer program product for being executed on computer, the computer being an image forming apparatus capable of receiving, from a first external device that stores first information, the first information being information for an operation in the image forming apparatus, including: detecting an access attempt from the first external device and receiving the first information; and displaying an operating screen for accepting an action performed on the image forming apparatus based on the received first information.

### BRIEF DESCRIPTION OF THE DRAWINGS

FIG. 1 is a diagram illustrating an example configuration of an image forming system of an embodiment;

FIG. 2 is a diagram illustrating an example hardware configuration of an MFP of the embodiment;

FIG. 3 is a diagram illustrating an example software configuration of the MFP of the embodiment;

FIG. 4 is a diagram illustrating example functional components of the MFP of the embodiment;

FIG. 5 is a diagram illustrating an example of data in an address book;

FIG. 6 is a diagram illustrating example functional components of an IC card;

FIG. 7 is a conceptual diagram illustrating relationship between information stored in the IC card and applications;

FIG. 8 is a diagram illustrating an example of data in an association table;

FIG. 9 is a diagram illustrating an example layout of a home screen;

FIG. 10 is a diagram illustrating an example layout of a screen of a scanner application;

FIG. 11 is a flowchart illustrating steps of a process performed in the image forming system;

FIG. 12 is a flowchart illustrating a subroutine of S4 of FIG. 11;

FIG. 13 is a flowchart illustrating a subroutine of S13 of FIG. 12; and

FIG. 14 is a flowchart illustrating a subroutine of S13 of FIG. 12.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

The present invention has an object to provide an image forming apparatus, an information processing method, and a computer program product capable of reducing a user's efforts expended to use an image forming apparatus where the user's settings are not stored.

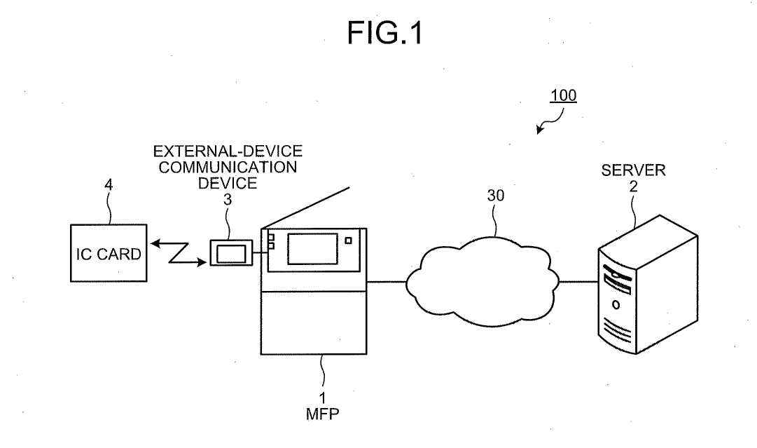

As illustrated in FIG. 1, an image forming system 100 according to an embodiment includes an MFP 1, a server 2, an external-device communication device 3, and an IC card 4. The MFP 1 and the server 2 are connected to each other via a network 30, such as the Internet. The external-device communication device 3 is connected to the MFP 1.

The MFP 1 has various functions including a copier function, a scanner function, a facsimile function, and a printer function. Furthermore, the MFP 1 is capable of receiving, via the external-device communication device 3, operating information (first information) for an operation(s) in the MFP 1 from the IC card 4 (an example of external device (first external device)) that stores the operating information.

In the present embodiment, the following assumption is made: a user (hereinafter, sometimes referred to as “regular user”) that regularly uses the MFP 1 at the user's work location (which may be a head office or a branch office) or the like stores the user's various preferred settings in the MFP 1; the user has an NFC (Near Field Communication) contactless IC card; and the user uses the MFP using the stored preferred settings after performing user authentication with the IC card. Information for user authentication of the regular user (user identification information) (second information) is stored in an address book (address data) of the MFP 1. The user authentication is performed by searching through the address book for the regular user information. When the regular user information is found in the address book, a result that the regular user is successfully authenticated is yielded. This will be described in detail later.

The following assumption is also made: a user (hereinafter, sometimes referred to as “external user”) that usually uses an MFP at the user's work location (which may be a head office or a branch office) visits another location (which may be another branch office or a location outside the user's work location) and uses the MFP 1 of the image forming system 100 installed at the other location. In this situation, it is assumed as follows. Because the external user does not regularly use the MFP 1, as is naturally the case, the external user's preferred settings are not stored in the MFP 1. The external user carries, as an IC card where operating information is stored, an IC card (e.g., a contact-type IC card to be connected via a USB port) that differs in type from the above-described NFC contactless IC card so that the external user can use the MFP 1. Although information about the external user is not registered in the address book of the MFP 1, the external user can use the MFP 1 without user authentication because the external user is a holder of the IC card where the operating information is stored in advance.

Hereinafter, “user-authentication IC card” (second external device), denotes the IC card carried by the regular user; the “IC card 4” denotes the IC card carried by the external user. Each of the user-authentication IC card and the IC card 4 may be simply referred to as “IC card” when no differentiation is made therebetween.

Hereinafter, when no differentiation is made between the regular user and the external user or when whether a user is either the regular user or the external user is not determined, the user may be simply referred to as “user”.

Examples of an external device the external user uses to use the MFP 1 include a portable terminal device and an IC card. As described above, the present embodiment is described through an example where the IC card is used. Accordingly, in the present embodiment, the external-device communication device 3 may specifically be embodied as an IC card reader.

For example, when a user brings the IC card 4 to proximity of the external-device communication device 3 (i.e., holds the IC card 4 over the external-device communication device 3), the external-device communication device 3 reads a variety of information including the identification information recorded in the IC card 4. In the present embodiment, it is assumed that the IC card reader that embodies the external-device communication device 3 is capable of, but not limited to, reading information from an IC card irrespective of whether the IC card is a contactless IC card or a contact-type IC card. Alternatively, the IC card reader may be of any specification so long as the IC card reader is adapted to types of the IC cards to be used (the IC card 4 and the user-authentication IC card). Hence, an IC card reader of any one of various known configurations can be used.

The server 2 stores image data and the like received from the MFP 1 and stores settings information regarding the MFP 1.

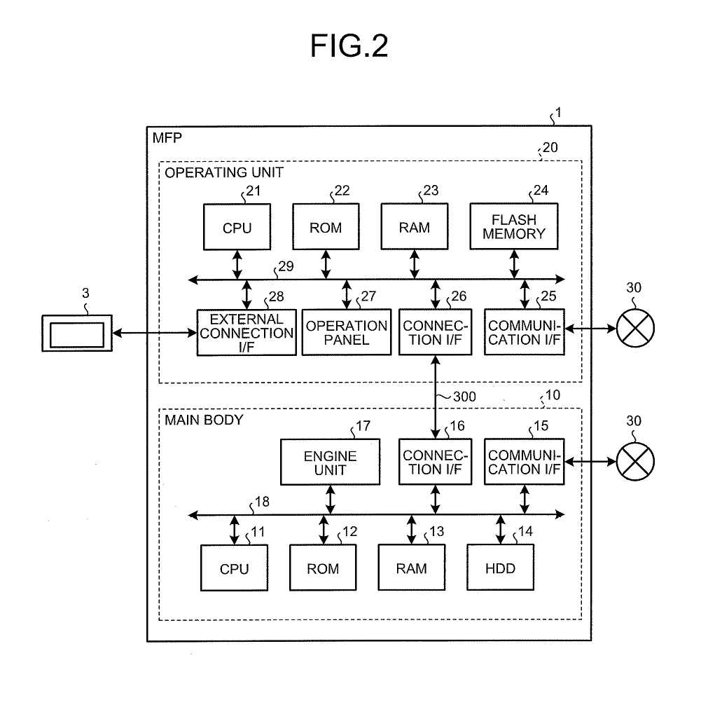

A hardware configuration of the MFP 1 is described below with reference to FIG. 2. As illustrated in FIG. 2, the MFP 1 includes a main body 10 capable of implementing various functions including a copier function, a scanner function, a facsimile function, and a printer function and an operating unit 20 that accepts a user's action. The “accepting a user's action” is a concept including accepting information (including signals representing coordinate values on a screen) entered by the user's action. The main body 10 and the operating unit 20 are communicably connected to each other via a dedicated communication channel 300. As the communication channel 300, any communication channel, irrespective of wired or wireless, compliant to a desired standard may be used as the communication channel 300; for example, a communication channel compliant to a USB (Universal Serial Bus) standard can be used.

The main body 10 can perform an operation that depends on an action accepted at the operating unit 20. Furthermore, the main body 10 can communicate also with external equipment, such as a client PC (Personal Computer), and perform an operation in accordance with an instruction received from the external equipment.

A hardware configuration of the main body 10 is described below. The main body 10 includes a CPU (Central Processing Unit) 11, a ROM (Read Only Memory) 12, a RAM (Random Access Memory) 13, an HDD (Hard Disk Drive) 14, a communication I/F (interface) 15, a connection I/F 16, and an engine unit 17 that are connected to each other via a system bus 18.

The CPU 11 performs centralized control of operations of the main body 10. Specifically, the CPU 11 executes program instructions (hereinafter, “program”) stored in the ROM 12, the HDD 14, or the like using the RAM 13 as a work area, thereby controlling operations of the entire main body 10 and implementing the above-described various functions including the copier function, the scanner function, the facsimile function, and the printer function.

The communication I/F 15 is an interface for connection with the network 30. The connection I/F 16 is an interface for communicating with the operating unit 20 via the communication channel 300.

The engine unit 17 is hardware that performs general-purpose information processing and processing, other than communication processing, for implementing the copier function, the scanner function, the facsimile function, and the printer function. For example, the engine unit 17 includes a scanner that reads in an image of an original document by scanning the original document, a plotter that performs printing on a sheet material such as paper, and a facsimile unit that performs facsimile communication. The engine unit 17 may further include a certain optional unit(s), such as a finisher that sorts out printed sheets of the sheet material and an ADF (Automatic Document Feeder) that automatically feeds the original document.

A hardware configuration of the operating unit 20 is described below. The operating unit 20 includes a CPU 21, a ROM 22, a RAM 23, a flash memory 24, a communication I/F 25, a connection I/F 26, an operation panel 27, and an external connection I/F 28 that are connected to each other via a system bus 29.

The CPU 21 performs centralized control of operations of the operating unit 20. Specifically, the CPU 21 executes a program(s) stored in the ROM 22, the flash memory 24, or the like using the RAM 23 as a work area, thereby controlling operations of the entire operating unit 20 and implementing various functions including displaying information (image) associated with an accepted input that is entered by a user.

The communication I/F 25 is an interface for connection with the network 30. The connection I/F 26 is an interface for communicating with the main body 10 via the communication channel 300.

The operation panel 27 accepts various inputs, each depending on a user's action, and displays a variety of information (e.g., information associated with the accepted action, information indicating an operating status of the MFP 1, and information indicating current settings). For example, the operation panel 27 may be implemented as, but not limited to, an LCD (Liquid Crystal Display) device embedded with a touch screen function. Alternatively, the operation panel 27 may be implemented as an organic EL (Electro Luminescence) display device embedded with a touch screen function. The operation panel 27 may include, in addition to or in lieu of such a display device, an operating unit, such as a hardware key, and an indicator, such as a lamp.

The external connection I/F 28 is an interface for connection with the above-described external-device communication device 3.

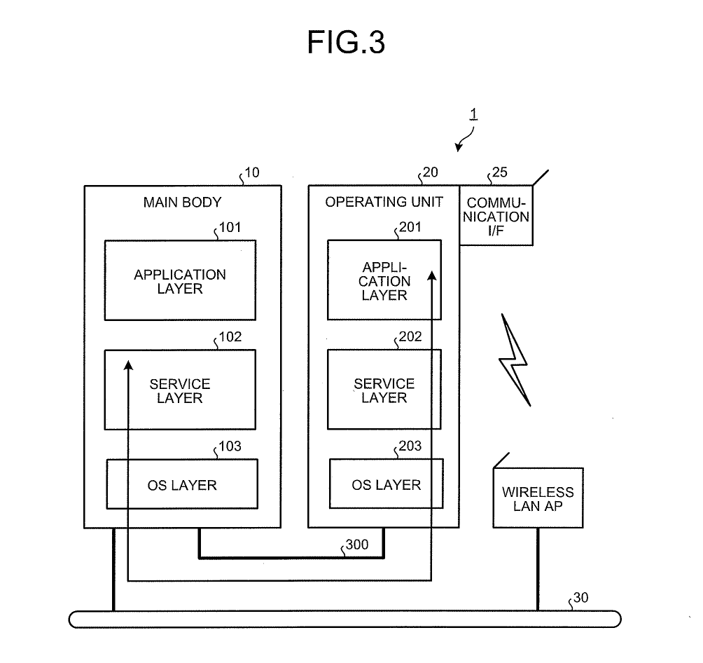

A software configuration of the MFP 1 is described below with reference to FIG. 3. As illustrated in FIG. 3, the main body 10 includes an application layer 101, a service layer 102, and an OS (Operating System) layer 103. The application layer 101, the service layer 102, and the OS layer 103 are implemented in a variety of software stored in the ROM 12, the HDD 14, or the like. The various functions are provided by the CPU 11 by executing the variety of software.

The software of the application layer 101 is application software (hereinafter, sometimes simply referred to as “applications”) that provides predetermined functions by utilizing hardware resources. Examples of the applications include a copier application providing the copier function, a scanner application providing the scanner function, a facsimile application providing the facsimile function, and a printer application providing the printer function.

The software of the service layer 102 is software that provides an interface, which is interposed between the application layer 101 and the OS layer 103, that enables the applications to utilize the hardware resources included in the main body 10. More specifically, the software of the service layer 102 provides a function of accepting operation requests, each requesting to utilize a hardware resource(s), and a function of arbitrating the operation requests. Examples of the operation requests that may be accepted by the service layer 102 include a request requesting to perform reading using the scanner and a request requesting to perform printing using the plotter.

The service layer 102 provides the interface function not only to the application layer 101 of the main body 10 but also to an application layer 201 of the operating unit 20. Hence, the application layer 201 (applications) of the operating unit 20 can implement functions that utilize the hardware resource(s) (e.g., the engine unit 17) of the main body 10 via the interface function of the service layer 102.

The software of the OS layer 103 is basic software (operating system) that provides basic functions for controlling hardware included in the main body 10. The software of the service layer 102 converts a request given from an application, which is one of the various applications, requesting to utilize a hardware resource(s) into a command interpretable by the OS layer 103 and passes the command to the OS layer 103. The software of the OS layer 103 executes the command, thereby causing the hardware resource(s) to operate in accordance with the application's request.

Similarly, the operating unit 20 includes the application layer 201, a service layer 202, and an OS layer 203. The application layer 201, the service layer 202, and the OS layer 203 included in the operating unit 20 are similar to those of the main body 10 in hierarchal architecture. However, functions provided by the applications of the application layer 201 and types of operation requests acceptable by the service layer 202 differ from those of the main body 10. The applications of the application layer 201 may be software that provides predetermined functions by utilizing the hardware resource(s) included in the operating unit 20. However, the applications of the application layer 201 are mainly software that provides UI (User Interface) functions that perform operations and display related to the functions (the copier function, the scanner function, the facsimile function, and the printer function) provided by the main body 10.

In the present embodiment, the software of the OS layer 103 of the main body 10 and the software of the OS layer 203 of the operating unit 20 differ from each other to maintain functional independence. More specifically, the main body 10 and the operating unit 20 operate on different operating systems independently of each other. For example, a configuration, in which Linux (registered trademark) is used as the software of the OS layer 103 of the main body 10, whereas Android (registered trademark) is used as the software of the OS layer 203 of the operating unit 20, can be employed.

As described above, because, in the MFP 1 of the present embodiment, the main body 10 and the operating unit 20 operate on different OSes, communication between the main body 10 and the operating unit 20 is performed as communication between different apparatuses rather than inter-process communication within a same apparatus. Examples of the communication between the main body 10 and the operating unit 20 include transmitting information (which describes an instruction given from a user) accepted by the operating unit 20 from the operating unit 20 to the main body 10 (command communication) and transmitting a notification of an event from the main body 10 to the operating unit 20. In this example, the operating unit 20 can use the functions of the main body 10 by performing the command communication to the main body 10. Examples of the event, notification of which is transmitted from the main body 10 to the operating unit 20, include a current status of an operation performed in the main body 10 and settings configured in the main body 10.

In the present embodiment, supplying electric power to the operating unit 20 is performed from the main body 10 via the communication channel 300. Accordingly, power supply to the operating unit 20 can be controlled separately from (independently of) power supply control of the main body 10.

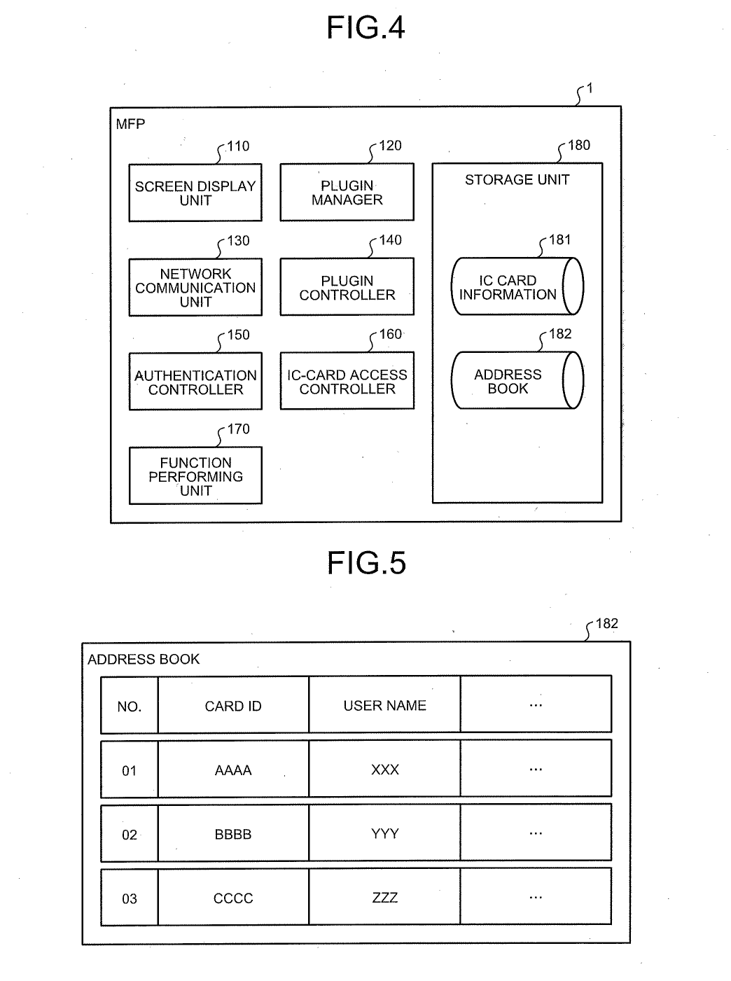

Functional components of the MFP 1 are described below. FIG. 4 is a block diagram illustrating example functional components of the MFP 1. As illustrated in FIG. 4, the MFP 1 includes a screen display unit 110, a plugin manager 120, a network communication unit 130, a plugin controller 140, an authentication controller 150, an IC-card access controller 160 (external-device access controller), a function performing unit 170, and a storage unit 180. Although FIG. 4 mainly illustrates functions related to the present invention for convenience of description, the functions provided by the MFP 1 are not limited to those illustrated in FIG. 4.

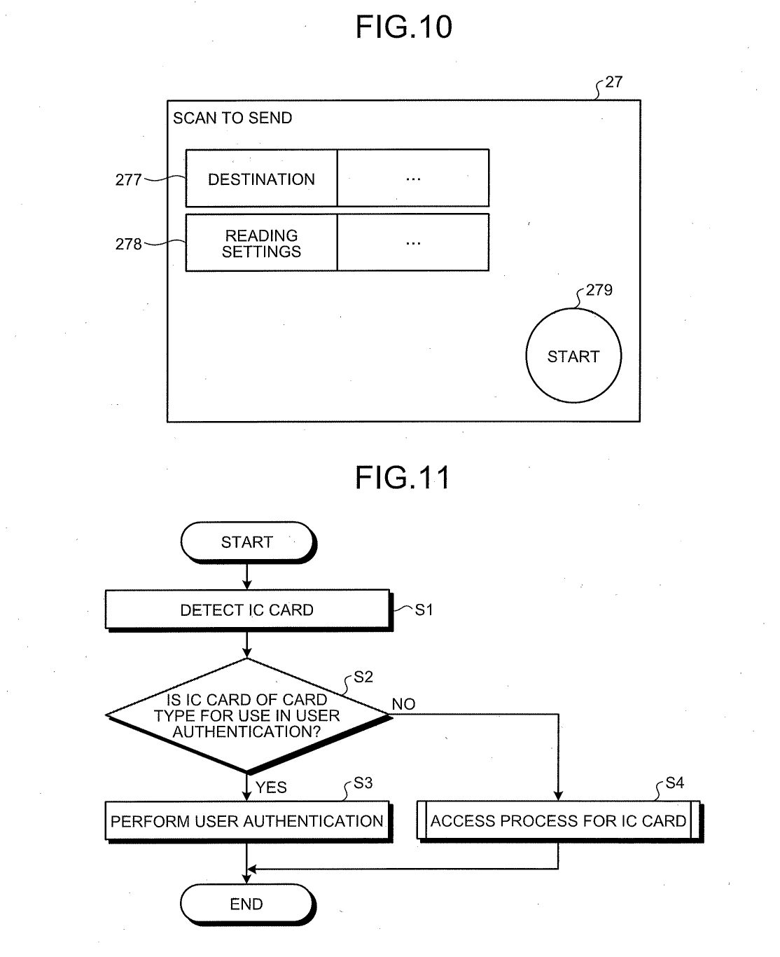

The screen display unit 110 causes a home screen (FIG. 9) of the MFP 1, a screen of an application that is to be operated (FIG. 10), and the like to be displayed for a user on the operation panel 27 (FIG. 2).

FIG. 9 is a diagram illustrating an example layout of the home screen. As illustrated in FIG. 9, the home screen is displayed on the operation panel 27. Specifically, a copier button 271, a printer button 272, a scanner button 273, a FAX button 274, an address book button 275, and a setting button 276 are displayed. Operating (touching) one of the buttons causes transition to a corresponding next screen to occur. For example, operating the scanner button 273 causes transition to the screen of FIG. 10 to occur.

FIG. 10 is a diagram illustrating an example layout of a screen of the scanner application. A destination entry field 277, a reading-setting entry field 278, and a start button 279 are displayed on this screen on the operation panel 27.

Referring back to FIG. 4, the screen display unit 110 displays an operating screen for accepting an action performed on the MFP 1 based on operating information received from the IC card 4. This will be described in detail later. The screen display unit 110 also displays, on the operation panel 27, an operating screen that is based on reference data associated, in the operating information, with a screen-and-display state of the operation panel 27 of an instant when the IC-card access controller 160 receives the operating information from the IC card 4. This will be described in detail later.

The plugin manager 120 manages a plugin(s) that can be optionally added or customized.

The network communication unit 130 operates to perform communication between the MFP 1 and external equipment.

The plugin controller 140 unifies interfaces of a plurality of standards, that differ depending on a communication channel of the IC card 4 and that of the user-authentication IC card, for the plugin(s) managed by the plugin manager 120.

The authentication controller 150 controls user login (user authentication) to the MFP 1 based on information (a user ID and a password) about a user entered using a software keyboard on the operation panel 27 or user information read out from the user-authentication IC card. Specifically, the authentication controller 150 determines that the user is successfully authenticated when the user information is found in an address book 182 (which will be described in detail later) but, otherwise, that the user is not authenticated.

When the IC-card access controller 160 detects an access attempt from a user-authentication external device that differs in type from the IC card 4, the authentication controller 150 performs user authentication by searching through the address book 182 stored in the storage unit 180 for user information transmitted from the user-authentication external device.

The IC-card access controller 160 detects, via the external-device communication device 3, an access attempt from the IC card 4 and an access attempt from the user-authentication IC card while distinguishing the accesses by the type of the IC card, and receives operating information from the IC card 4 but receives user information from the user-authentication IC card.

The function performing unit 170 performs the function(s), such as the copier function, the scanner function, the facsimile function, and the printer function, of the MFP 1 in accordance with an instruction entered by a user using the operation panel 27.

The storage unit 180 stores IC card information 181 and the address book 182.

Types of IC cards (e.g., the NFC contactless IC card 4 and the contact-type IC card to be connected via a USB port) adaptable by the MFP 1 are stored in the IC card information 181.

Information about regular users is registered in the address book 182. FIG. 5 is a diagram illustrating an example of data in the address book 182. As the information about regular users, information including card IDs and user names is stored on a per-number (No.) basis in the address book 182.

The above-described screen display unit 110, the plugin manager 120, the network communication unit 130, the plugin controller 140, the authentication controller 150, the IC-card access controller 160, and the function performing unit 170 may be implemented by, but not limited to, the CPU (11 or 21) by executing a program stored in a storage device (e.g., the ROM 12, the HDD 14, the ROM 22, or the flash memory 24). Alternatively, for example, at least a part of these units may be implemented in a dedicated hardware circuit (e.g., a semiconductor integrated circuit). The storage unit 180 may be implemented in the HDD 14 or the like of the main body 10 or, alternatively, implemented in the flash memory 24 or the like of the operating unit 20, for example.

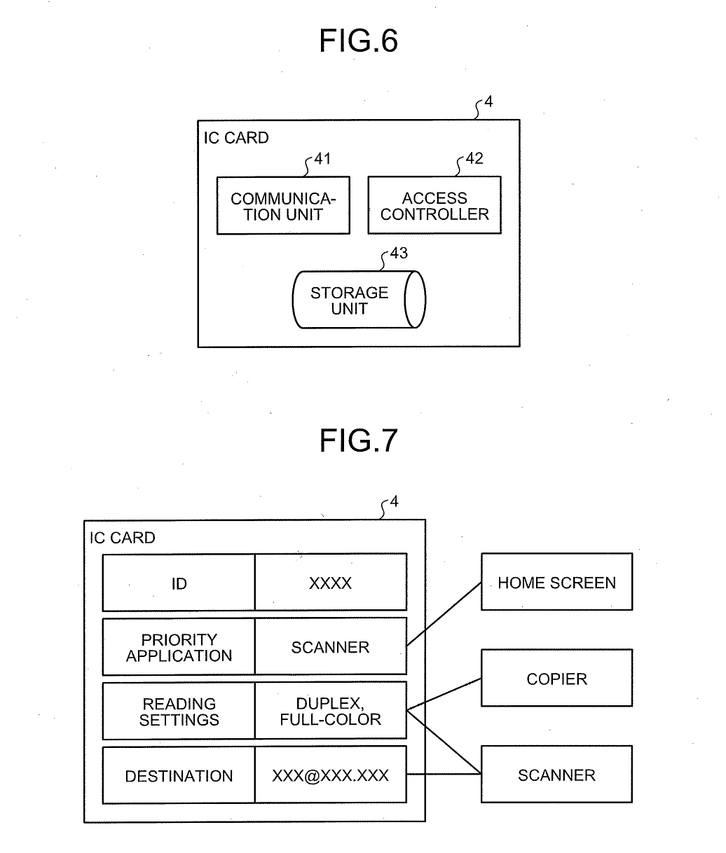

Functional components of the IC card 4 are described below. FIG. 6 is a diagram illustrating example functional components of the IC card 4. The IC card 4 includes, as its functional components, a communication unit 41, an access controller 42, and a storage unit 43.

The communication unit 41 transmits and receives information to and from the MFP 1.

The access controller 42 controls the communication unit 41 and performs writing and reading information to and from the storage unit 43, and the like.

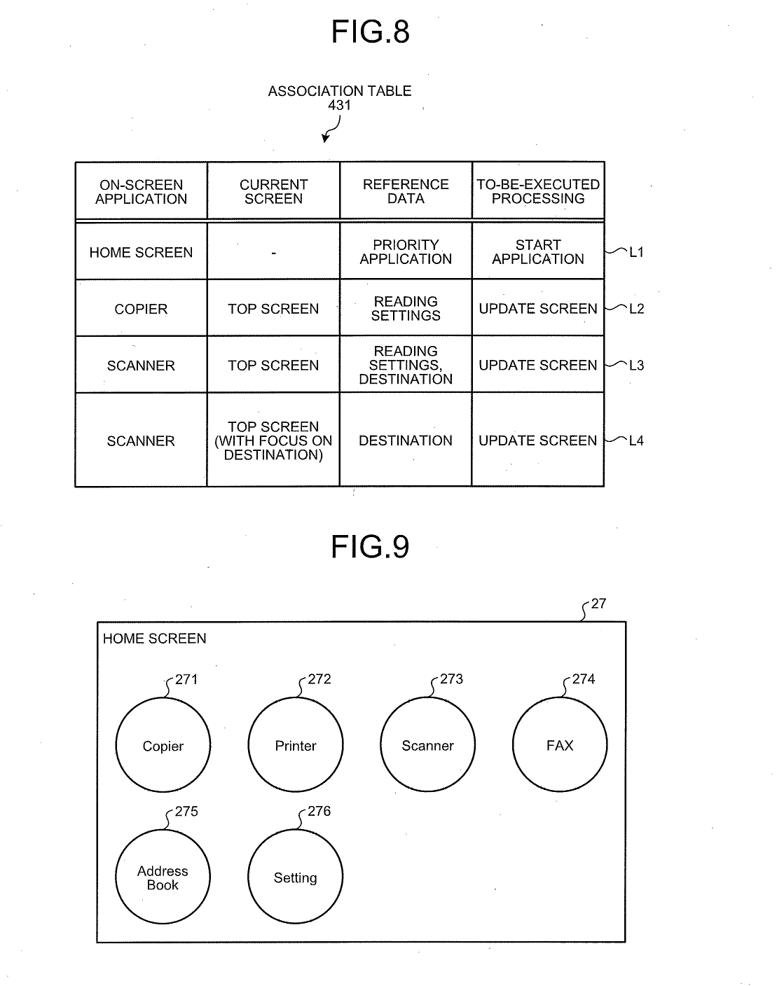

Information stored in the storage unit 43 is described below with reference to FIG. 7 and FIG. 8. FIG. 7 is a conceptual diagram illustrating the information stored in the IC card 4, and relationship between the information and applications. FIG. 8 is a diagram illustrating an example of data in an association table stored in the storage unit 43.

As illustrated in FIG. 7, information including an Id, by which a user is identified, a priority application (an application that is to be started with higher priority), reading settings (e.g., duplex, full-color), and destination (e.g., an e-mail address to which data is to be transmitted) is stored in (the storage unit 43 of) the IC card 4.

An association table 431 illustrated in FIG. 8 is also stored in the storage unit 43 of the IC card 4. In the association table 431, information items, which are on-screen application, current screen, reference data, and to-be-executed processing that are arranged in this order from the left, are associated with each other. Specifically, a plurality of reference data items, which differ depending on a screen-and-display state (the on-screen application and the current screen) of the MFP 1, are stored in the association table 431 as operating information.

With reference to FIG. 7 in addition to FIG. 8, for example, a line L1 of the association table 431 of FIG. 8 indicates that, when the on-screen application is the home screen application, the priority application (which is the scanner application in FIG. 7) is to be used as reference data; and starting the application is to be performed as to-be-executed processing.

A line L2 indicates that, when the on-screen application is the copier application, the current screen is TOP screen; the reading settings are to be used as reference data; and the screen is to be updated as to-be-executed processing.

A line L3 indicates that, when the on-screen application is the scanner application and the current screen is the TOP screen with no focus on the destination (a state where a software keyboard for use in entering a destination is not displayed), the reading settings and the destination are to be used as reference data, and the screen is to be updated as to-be-executed processing.

A line L4 indicates that, when the on-screen application is the scanner application and the current screen is the TOP screen with a focus on the destination (a state where the software keyboard for use in entering a destination is displayed), the destination is to be used as reference data, and the screen is to be updated as to-be-executed processing.

As can be seen from FIG. 7 and FIG. 8, the plurality of information items (the reference data) for use by the MFP 1 are stored in the IC card 4. The reference data to be used varies depending on an on-screen application and a current screen of the MFP 1. Some of the information items (the reference data) are used by a plurality of applications in a shared manner. An example of such an information item is the reading settings in the example of FIG. 7 and FIG. 8.

Although FIG. 6 illustrates functional components of the example where the external device is the IC card 4, when the external device is a portable terminal device, functions of the communication unit 41, the access controller 42, and the storage unit 43 may be included in an OS or provided on a per-application basis of applications that run on the OS.

An example of an operating procedure of the image forming system 100 according to the present embodiment is described below with reference to FIG. 11. FIG. 11 is a flowchart illustrating steps of a process performed in the image forming system 100.

When a user holds an IC card, which belongs to the user, over the external-device communication device 3, the IC-card access controller 160 detects an access attempt, from the IC card via the external-device communication device 3 (S1).

Next, at S2, the IC-card access controller 160 determines whether or not the IC card is of a card type for use in user authentication or, in short, whether or not the IC card is the user-authentication IC card. When the IC card is the user-authentication IC card (Yes at S2), processing proceeds to S3. When the IC card is the IC card 4 (No at S2), processing proceeds to S4.

At S3, the authentication controller 150 performs user authentication (user login) based on user information read out from the user-authentication IC card. Specifically, the authentication controller 150 determines that the user is successfully authenticated when the user information is found in the address book 182 but, otherwise, that the user is not authenticated. Because processing at S3 and the following steps is similar to that of the conventional techniques, description thereof is omitted.

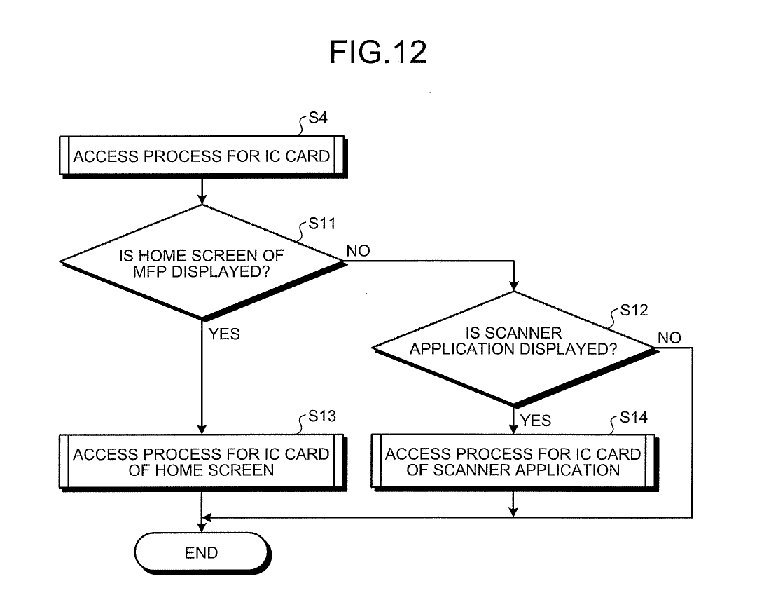

At S4, the IC-card access controller 160 performs an access process for the IC card 4. Processing at S4 is described below with reference to FIG. 12.

As illustrated in FIG. 12, at S11, the IC-card access controller 160 determines whether or not the home screen of the MFP 1 is displayed. When the home screen is displayed (Yes at S11), processing proceeds to S13; otherwise (No at S11), processing proceeds to S12. The determination at S11 can be implemented by specifying, by the screen display unit 110, an application that is currently displayed on the operation panel 27, for example.

At S12, the IC-card access controller 160 determines whether or not the scanner application is displayed. When the scanner application is displayed (Yes at S12), processing proceeds to S14; otherwise (No at S12), processing at S4 ends. Note that the determination at S12 is made about the scanner application for exemplary purpose only, and processing can be performed in a similar manner when the determination is made about another application, such as the copier application, the facsimile application, and the printer application.

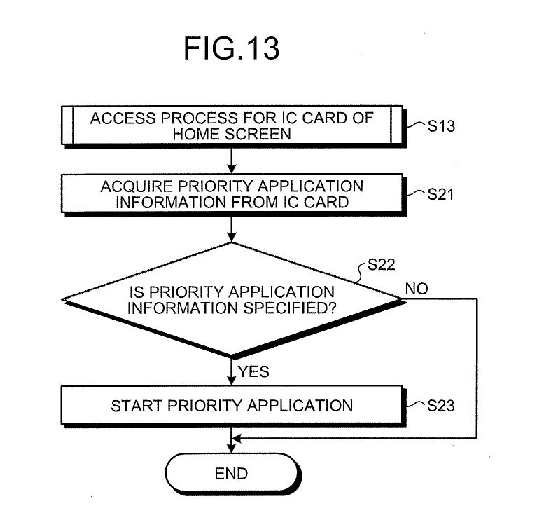

At S13, the IC-card access controller 160 performs an access process for the IC card 4 of the home screen. Processing at S13 is described below with reference to FIG. 13.

As illustrated in FIG. 13, at S21, the IC-card access controller 160 acquires priority application information from the IC card 4.

Next, at S22, the IC-card access controller 160 determines whether or not the priority application information is specified in the IC card 4. When the priority application information is specified (Yes at S22), processing proceeds to S23; otherwise (No at S22), processing at S13 ends.

At S23, the IC-card access controller 160 causes the function performing unit 170 to start the priority application. In the example of FIG. 7, the scanner application, which is the priority application, is started; the screen display unit 110 causes the screen of FIG. 10, for example, to be displayed on the operation panel 27.

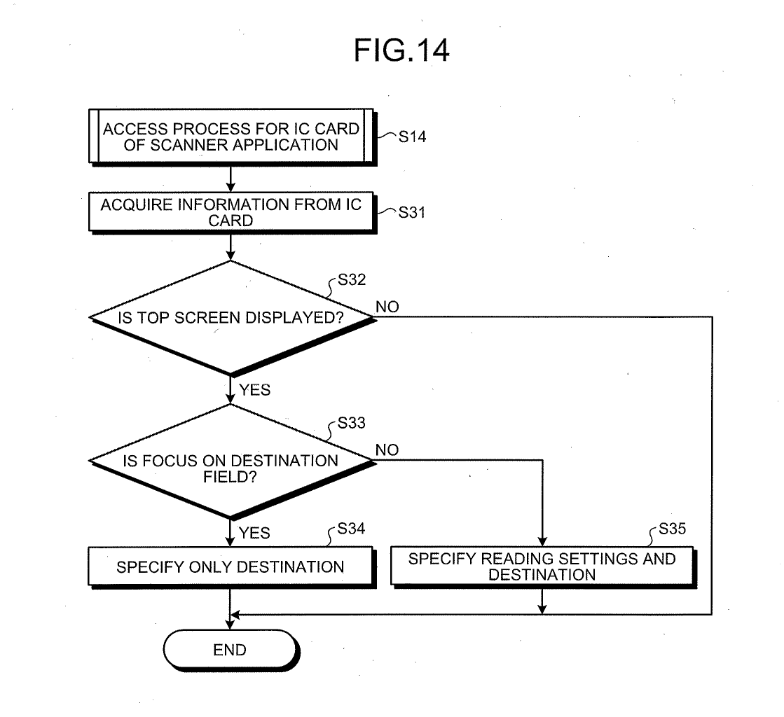

Referring back to FIG. 12, at S14, the IC-card access controller 160 performs an access process for the IC card 4 of the scanner application. Processing at S14 is described below with reference to FIG. 14. Note that processing at S14 may be performed when, for example, an external user holds the IC card 4 over the external-device communication device 3 in a state where the screen of FIG. 10 is displayed upon start of the scanner application at S23 of FIG. 13.

As illustrated in FIG. 14, at S31, the IC-card access controller 160 acquires information (see FIG. 7 and FIG. 8) from the IC card 4.

Next, at S32, the IC-card access controller 160 determines whether or not the TOP screen is displayed. When the TOP screen is displayed (Yes at S32), processing proceeds to S33; otherwise (No at S32), processing at S14 ends.

At S33, the IC-card access controller 160 determines whether or not a focus is on the destination field on the screen. When a focus is on the destination field (Yes at S33), processing proceeds to S34; otherwise (No at S33), processing proceeds to S35.

At S34, the IC-card access controller 160 specifies only a destination (in the destination entry field 277 of FIG. 10) based on the line L4 of the association table 431 of FIG. 8.

At S35, the IC-card access controller 160 specifies reading settings (in the reading-setting entry field 278 of FIG. 10) and a destination (in the destination entry field 277 of FIG. 10) based on the line L3 of the association table 431 of FIG. 8.

After S34 or S35 has been processed, processing at S14 ends.

As described above, according to the image forming system 100 of the present embodiment, by virtue of using the IC card 4 where the operating information is stored in advance, an external user's effort expended to use the MFP 1 where the user's preferred settings are not stored can be reduced.

Furthermore, a plurality of reference data items, which differ depending on the screen-and-display state (the on-screen application and the current screen of FIG. 8) of the MFP 1, are stored as the operating information in the IC card 4. Accordingly, the external user can start a priority application only by holding the IC card 4 over the external-device communication device 3 when the home screen is displayed; furthermore, the external user can specify reading settings and a destination only by holding the IC card 4 over the external-device communication device 3 when the screen of the scanner application is displayed.

The IC-card access controller 160 detects, via the external-device communication device 3, an access attempt from the IC card 4 and an access attempt from an user-authentication external device while distinguishing these access attempts from each other (S2 of FIG. 11). This detection makes it possible to perform operation differently and appropriately such that, when the access attempt is from the IC card 4, the process based on the operating information stored in the IC card 4 (S4 of FIG. 11) is performed but, when the access attempt is from the user-authentication IC card, the user authentication process based on user information stored in the user-authentication external device (S3 of FIG. 11) is performed.

An embodiment according to the present invention has been described above. However, the embodiment is not intended to limit the present invention. The present invention may be embodied in various manners by modifying elements without departing from the scope of the present invention.

For example, in contrast to the above-described embodiment described through an example where the external device is an IC card, a portable terminal device, such as a smartphone, may be used as the external device. In this case, the external-device communication device 3 is preferably embodied as a communication device communicable with the portable terminal device.

The above-described embodiment is described through an example where devices of different types are the “IC card 4” (first external device) and the “user-authentication IC card” (second external device) and, at S2 of FIG. 11, bifurcation between the route to S3 and the route to S4 occurs depending on the type. However, the method for bifurcation is not limited thereto. For example, a method, in which only the user-authentication IC card is used, and the operating information stored in the IC card 4 in the above-described embodiment is stored in the user-authentication IC card, can be used. With this method, at S2 of FIG. 11, processing may preferably proceed to S4 when, for example, user identification information is not found in the user-authentication IC card or when, even though user identification information is found in the user-authentication IC card, the user identification information is not found in the address book (FIG. 4 and FIG. 5) of the MFP 1. With this method, because a user is to carry only the user-authentication IC card, card management can be facilitated.

The above description has been made on an assumption that the main body 10 and the operating unit 20 of the MFP 1 of the embodiment are independent of each other in terms of both hardware and software; however, the configuration is not limited thereto, and the main body 10 and the operating unit 20 may be integrated in terms of either one or both of hardware and software.

Furthermore, various embodiments can be made by appropriately combining the plurality of elements disclosed in the above-described embodiment. For example, some elements may be omitted from the elements described in the embodiment.

The program to be executed by the MFP 1 of the above-described embodiment may be configured to be provided as an installable file or an executable file recorded in a non-transitory, computer-readable recording medium such as a CD-ROM, a flexible disk (FD), a CD-R, a DVD (Digital Versatile Disk), and a USB (Universal Serial Bus) or, alternatively, may be configured to be provided or delivered via a network, such as the Internet. Various programs may be configured to be provided in a preloaded form loaded into a non-volatile recording medium, such as a ROM, in advance.

It should be noted that a person skilled in the field of information processing technology may employ the present invention using application specific integrated circuits (ASIC) or an apparatus in which circuit modules are connected.

Further, each of functions (units) may be implemented by one or more circuits.

It should be noted that, in the specification, the circuit may include a processor programmed by software to execute the corresponding functions and hardware which is designed to execute the corresponding functions such as the ACIC and the circuit module.

The above-described embodiment is described through an example where the image processing apparatus according to an aspect of the invention is applied to an MFP having at least two functions of the copier function, the scanner function, the facsimile function, and the printer function; however, the image processing apparatus is applicable to any image forming apparatus, such as a copier, a scanner, a facsimile, and a printer.

According to the present embodiments, a user's efforts expended to use an image forming apparatus where the user's settings are not stored can be reduced.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An image forming apparatus capable of receiving, from a first external device that stores first information, the first information being information for an operation in the image forming apparatus, the image forming apparatus comprising:
an external-device access controller configured to detect an access from the first external device and receive the first information; and
a screen display configured to display an operating screen for accepting an action performed on the image forming apparatus based on the received first information.

2. The image forming apparatus according to claim 1, wherein
the first external device stores, as the first information, a plurality of referent data items that differ depending on a screen-and-display state of the image forming apparatus, and
the screen display displays an operating screen that is based on reference data associated with a screen-and-display state of the screen display of when the first information is received by the external-device access controller.

3. The image forming apparatus according to claim 1, further comprising a storage configured to store address data, in which information about one or more users is registered, wherein
the first external device further stores second information containing user identification information for use in user authentication, and
the external-device access controller causes, when the user identification information contained in the second information that is received in an access made from the first external device is not found in the information about the one or more users indicated by the address data stored in the storage, the screen display to display an operating screen based on the first information.

4. The image forming apparatus according to claim 1, further comprising:
a storage configured to store address data, in which information about one or more users is registered; and
an authentication controller configured to perform user authentication before the screen display displays an operating screen, wherein
the external-device access controller detects an access from the first external device together with a type of the first external device and an access from a second external device, the second external device being for use in user authentication and differing in type from the first external device, together with a type of the second external device,
when an access detected by the external-device access controller is from the first external device, the screen display displays an operating screen based on the first information received from the first external device, and
when an access detected by the external-device access controller is from the second external device, the authentication controller performs user authentication by searching through the address data stored in the storage based on second information containing user identification information received from the second external device.

5. An information processing method performed by an image forming apparatus capable of receiving, from a first external device that stores first information, the first information being information for an operation in the image forming apparatus, the information processing method comprising:
detecting an access from the first external device and receiving the first information; and
displaying an operating screen for accepting an action performed on the image forming apparatus based on the received first information.

6. The information processing method according to claim 5, wherein
the first external device stores, as the first information, a plurality of referent data items that differ depending on a screen-and-display state of the image forming apparatus, and
the displaying includes displaying an operating screen that is based on reference data associated with a screen-and-display state of when the first information is received is displayed.

7. The information processing method according to claim 5, wherein
the first external device further stores second information containing user identification information for use in user authentication,
the image forming apparatus further includes a storage configured to store address data, in which information about one or more users is registered, and
when user identification information contained in the second information that is received in an access made from the first external device is not found in the information about the one or more users indicated by the address data stored in the storage, the displaying includes an operating screen based on the first information.

8. The information processing method according to claim 5, further comprising controlling authentication, wherein
the image forming apparatus further includes a storage unit configured to store address data, in which information about one or more users is registered,
the detecting includes an access from the first external device is detected together with a type of the first external device, and an access from a second external device, the second external device being for use in user authentication and differing in type from the first external device, is detected together with a type of the second external device,
when an access detected is from the first external device, the displaying includes an operating screen based on the first information received from the first external device, and
when the access detected is from the second external device, the controlling authentication includes performing user authentication by searching through the address data stored in the storage unit based on second information containing user identification information received from the second external device.

9. A computer program product for being executed on computer, the computer being an image forming apparatus capable of receiving, from a first external device that stores first information, the first information being information for an operation in the image forming apparatus, comprising:
detecting an access attempt from the first external device and receiving the first information; and
displaying an operating screen for accepting an action performed on the image forming apparatus based on the received first information.

10. The computer program product according to claim 9, wherein
the first external device stores, as the first information, a plurality of referent data items that differ depending on a screen-and-display state of the image forming apparatus, and
the displaying includes displaying an operating screen that is based on reference data associated with a screen-and-display state of when the first information is received is displayed.

11. The computer program product according to claim 9, wherein
the first external device further stores second information containing user identification information for use in user authentication,
the image forming apparatus further includes a storage configured to store address data, in which information about one or more users is registered, and
when user identification information contained in the second information that is received in an access made from the first external device is not found in the information about the one or more users indicated by the address data stored in the storage, the displaying includes an operating screen based on the first information.

12. The computer program product according to claim 9, further comprising controlling authentication, wherein
the image forming apparatus further includes a storage configured to store address data, in which information about one or more users is registered,
the detecting includes an access from the first external device is detected together with a type of the first external device, and an access from a second external device, the second external device being for use in user authentication and differing in type from the first external device, is detected together with a type of the second external device,
when an access detected is from the first external device, the displaying includes an operating screen based on the first information received from the first external device, and
when the access detected is from the second external device, the controlling authentication includes performing user authentication by searching through the address data stored in the storage unit based on second information containing user identification information received from the second external device.
